(19) United States
(12) Patent Application Publication
(10) Pub. No.: US 2026/0006383 A1
(43) Pub. Date: Jan. 1, 2026

(54) PLANAR TRANSDUCER AND SPEAKER

(71) Applicants: Yongchun ZHANG, Shuangcheng, Heilongjiang (CN); Shenzhen Xinqi Science and Technology Co., Ltd., Shenzhen City, Guangdong (CN)

(72) Inventors: Yongchun ZHANG, Shuangcheng, Heilongjiang (CN); Zhiwei SU, Shenzhen City, Guangdong (CN)

(73) Assignee: Shenzhen Xinqi Science and Technology Co., Ltd., Shenzhen City, Guangdong (CN)

(21) Appl. No.: 18/879,558

(22) PCT Filed: Jul. 14, 2022
(86) PCT No.: PCT/CN2022/105702

§ 371 Date: Dec. 27, 2024

(30) Foreign Application Priority Data
Jun. 28, 2022 (CN) 202210742522.3

(51) Int. Cl. H04R 7/10; H04R 1/02; H04R 7/18; H04R 9/02; H04R 9/04; H04R 9/06

(52) U.S. Cl. CPC H04R 7/10; H04R 1/021; H04R 7/18; H04R 9/025; H04R 9/045; H04R 9/046; H04R 9/06; H04R 2307/025; H04R 2307/027

(57) ABSTRACT

A planar transducer and a speaker are provided. The planar transducer includes a basket, a magnetic circuit assembly, a membrane assembly and a cover plate. An accommodation cavity is provided in the basket, and one end of the accommodation cavity is provided with an opening. The magnetic circuit assembly is disposed in the accommodation cavity. The magnetic circuit assembly includes a magnetically conductive plate, and a magnet assembly attached to the plate. The magnet assembly includes a number N of first magnets and N−1 second magnets, N being greater than or equal to 3, the first magnets and the second magnets being arranged alternately attached to each other, magnetic pole directions of the first magnets being perpendicular to magnetic pole directions of the second magnets, and magnetic pole directions of any two magnets in the magnet assembly, adjacent and arranged alternately with another type of magnet, being arranged oppositely.

### TECHNICAL FIELD

The present disclosure belongs to the technical field of speakers, and specifically relates to a planar transducer and a speaker having the planar transducer.

### BACKGROUND

With the rapid development of electroacoustic products, people are having higher and higher requirements for sound quality. To achieve good sound performance, high resolution, high efficiency, and low distortion of speakers, innovation and improvement are needed. For tweeter speaker units, mid-range speaker units, or headphone speaker units, the traditional dome (i.e., moving coil speaker unit) mode can no longer meet the requirements of modern users and market. The adoption of planar speaker units has become a new standard promoted by more manufacturers.

At present, the magnetic energy of planar transducers in the prior art is relatively low, making the sound quality of planar transducers cannot meet the requirements of numerous consumers. In order to increase the magnetic energy in existing planar speaker units, the method of increasing the number of magnets is usually adopted, which requires setting double (i.e., two sets of) magnetic strips on front and rear sides of the planar membrane respectively. This makes the sound directly radiated to the ear from the front side of the membrane be blocked by the magnetic strip, causing obstruction and interference during propagation, thereby affecting the radiation effect of the sound and reducing the sound quality.

In addition, for traditional planar membrane materials, an ultra-thin nanoscale polyester film is used as a base layer, and a layer of aluminum foil is formed on the base layer under negative pressure; then a circuit is formed by etching, so that a planar circuit voice coil is finally formed. The most important reason for using this kind of material is to achieve the lightest mass per unit area of the membrane, thereby obtaining a higher sound pressure level, as well as ductility and analytical power at high frequency. Many brands take pride in this, but this polyester film similar to cling film has defects such as poor toughness, low rigidity modulus, and insufficient recovery force, which will reduce the quality of the membrane and the high fidelity of the sound. The first reason is that the sound is light and thin, lacking a sense of weight, and is not mellow enough. The second reason is that the light and thin membrane can cause distortion at medium and low frequencies in case of high power. The third reason is that the sound quality of etched aluminum voice coil will exhibit sharp and piercing burr sensation at high frequency.

### SUMMARY

An object of the present disclosure is to at least solve the problems of reduced quality of sound emitted from planar transducers caused by the obstruction and interference by magnetic strips during propagation, as well as distortion caused by planar membrane assembly. This object is achieved through the following technical solutions.

A first aspect of the present disclosure provides a planar transducer, which includes:
a basket, inside which an accommodation chamber is provided, one end of the accommodation chamber having an opening;
a magnetic circuit assembly, which is arranged in the accommodation chamber, and which includes a magnetically conductive plate and a magnet assembly attached to a plate surface of the magnetically conductive plate; in which the magnet assembly includes N first magnets and N−1 second magnets, where N is larger than or equal to 3; the first magnets and the second magnets are alternately attached to each other in sequence, a magnetic pole direction of the first magnets and a magnetic pole direction of the second magnets are perpendicular to each other, and any two adjacent magnets that are of the same type and arranged alternately with the other type of magnet in the magnet assembly have opposite magnetic pole directions;
a membrane assembly, which includes a base layer and a voice coil layer; in which the base layer is provided at an opening of the accommodation chamber and covers the opening, the voice coil layer is attached and connected to one side of the base layer, and the other side of the base layer is arranged toward the magnetic circuit assembly; and
a cover plate, which is provided at the opening of the accommodation chamber and covers the opening, and which is arranged opposite to the voice coil layer, a first sound output hole being provided on the cover plate.

According to the planar transducer of the present disclosure, multiple first magnets and multiple second magnets are alternately and closely attached in sequence, the magnetic pole direction of the first magnets and the magnetic pole direction of the second magnets are perpendicular to each other, and the magnetic pole directions of any two spaced-apart magnets of the same type in the multiple magnets are opposite to each other; therefore, by arranging the multiple magnets in a Halbach array, the magnetic flux of the magnetic circuit assembly is effectively increased and the sensitivity of the planar transducer is thereby improved. At the same time, the voice coil layer of the membrane assembly is placed on one side face of the base layer, and the magnetic circuit assembly is placed on the other side face of the base layer. When the planar transducer vibrates and emits a sound, the membrane assembly vibrates and emits a sound under the action of the magnetic field of the magnetic circuit assembly, and the sound is transmitted from the side of the base layer that is provided with the voice coil layer to the outside of the basket. During the transmission of sound, it is not obstructed or interfered by magnets, thereby reducing sound distortion and making the frequency response curve flatter, effectively improving the sound quality of the planar transducer.

In addition, the planar transducer according to the present disclosure may also have the following additional technical features.

In some embodiments of the present disclosure, the direction of the magnetic induction lines of the first magnet is parallel to the plate surface of the magnetically conductive plate, and the direction of the magnetic induction lines of the second magnet is perpendicular to the plate surface of the magnetically conductive plate; or the direction of the magnetic induction lines of the first magnet is perpendicular to the plate surface of the magnetically conductive plate, and the direction of the magnetic induction lines of the second magnet is parallel to the plate surface of the magnetically conductive plate.

In some embodiments of the present disclosure, end surfaces of any adjacent first magnet and second magnet on a side facing the magnetically conductive plate are alternately arranged in a concave and convex pattern, and end surfaces of any adjacent first magnet and second magnet on a side away from the magnetically conductive plate are flush.

In some embodiments of the present disclosure, in a direction perpendicular to the plate surface of the magnetically conductive plate, a height dimension of the first magnet is smaller than a height dimension of the second magnet, and a cross-sectional area of the first magnet is smaller than that of the second magnet.

In some embodiments of the present disclosure, in a direction parallel to the plate surface of the magnetically conductive plate, a width dimension of the first magnet is smaller than a width dimension of the second magnet, and a cross-sectional area of the first magnet is smaller than that of the second magnet.

In some embodiments of the present disclosure, the magnetically conductive plate includes a main plate portion and side plate portions arranged on both sides of the main plate portion; the main plate portion and the side plate portions on both sides together enclose a U-shaped structure, and the multiple magnets are arranged inside the U-shaped structure and are attached to the plate surface of the main plate portion.

In some embodiments of the present disclosure, the base layer and the voice coil layer of the membrane assembly are of an integrated structure, in which the base layer is a PI film and the voice coil layer is electrolytic copper attached to a surface of the PI film, and the electrolytic copper is etched to form the voice coil layer.

In some embodiments of the present disclosure, the membrane assembly further includes an anti-oxidation coating that covers a surface of the electrolytic copper of the voice coil layer.

In some embodiments of the present disclosure, the membrane assembly further includes a hanging edge, which is arranged around an edge of the base layer, and the base layer is connected to the basket through the hanging edge.

Another aspect of the present disclosure also provides a speaker, which includes the planar transducer as described in any one of the above items.

### BRIEF DESCRIPTION OF THE DRAWINGS

Upon reading the detailed description of the preferred embodiments below, various other advantages and benefits will become clear to those skilled in the art. The accompanying drawings are only used for the purpose of illustrating preferred embodiments, and should not be considered as a limitation to the present disclosure. Moreover, throughout the drawings, the same reference signs are used to denote the same components. In the drawings:

FIG. 1 is a schematic view of a cross-sectional structure of the planar transducer according to some embodiments of the present application;

FIG. 2 is a schematic view of a frontal structure of the planar transducer according to some embodiments of the present application;

FIG. 3 is a schematic view of an exploded structure of the planar transducer according to some embodiments of the present application;

FIG. 4 is a schematic structural view of the basket according to some embodiments of the present application;

FIG. 5 is a schematic structural view of the membrane assembly according to some embodiments of the present application;

FIG. 6 is a schematic structural view of the magnetic circuit assembly according to some embodiments of the present application;

FIG. 7 is a schematic structural view of the magnetically conductive plate according to some embodiments of the present application;

FIG. 8 is a schematic structural view of the magnet assembly according to some embodiments of the present application; and

FIG. 9 is a schematic view of an assembly structure of the base layer and the voice coil layer according to some embodiments of the present application.

### LIST OF REFERENCE SIGNS

1: planar transducer;
10: basket; 11: accommodation chamber; 12: first mounting seat; 13: second mounting seat;
20: magnetic circuit assembly; 21: magnetically conductive plate; 211: main plate portion; 212: side plate portion; 213: protrusion; 214: recess; 22: magnet assembly; 221: first magnet; 222: second magnet;
30: membrane assembly; 31: base layer; 32: voice coil layer; 33: hanging edge;
40: cover plate; 41: first sound output hole.

### DETAILED DESCRIPTION

Hereinafter, exemplary embodiments of the present disclosure will be described in greater detail with reference to the accompanying drawings. Although the exemplary embodiments of the present disclosure are shown in the drawings, it should be understood that the present disclosure may be implemented in various forms and should not be limited by the embodiments set forth herein. On the contrary, these embodiments are provided to enable a more thorough understanding of the present disclosure and to fully convey the scope of the present disclosure to those skilled in the art.

It should be understood that the terms used herein are only for the purpose of describing specific exemplary embodiments, and are not intended to be limitative. Unless clearly indicated otherwise in the context, singular forms “a”, “an”, and “said” as used herein may also mean that plural forms are included. Terms “include”, “comprise”, “contain” and “have” are inclusive, and therefore indicate the existence of the stated features, steps, operations, elements and/or components, but do not exclude the existence or addition of one or more other features, steps, operations, elements, components, and/or combinations thereof. The method steps, processes, and operations described herein should not be interpreted as requiring them to be executed in the specific order described or illustrated, unless the order of execution is clearly indicated. It should also be understood that additional or alternative steps may be used.

Although terms “first”, “second”, “third” and the like may be used herein to describe multiple elements, components, regions, layers and/or sections, these elements, components, regions, layers and/or sections should not be limited by these terms. These terms may only be used to distinguish one element, component, region, layer or section from another region, layer or section. Unless clearly indicated in the context, terms such as “first”, “second” and other numerical terms do not imply an order or sequence when they are used herein. Therefore, the first element, component, region, layer or section discussed below may be referred to as a second element, component, region, layer or section without departing from the teachings of the exemplary embodiments.

For ease of description, spatial relative terms may be used herein to describe the relationship of one element or feature relative to another element or feature as shown in the drawings. These relative terms are, for example, “inner”, “outer”, “inside”, “outside”, “below”, “under”, “above”, “over”, etc. These spatial relative terms are intended to include different orientations of the device in use or in operation in addition to the orientation depicted in the drawings. For example, if the device in the figure is turned over, then elements described as “below other elements or features” or “under other elements or features” will be oriented “above the other elements or features” or “over the other elements or features”. Thus, the exemplary term “below” may include orientations of both above and below. The device can be otherwise oriented (rotated by 90 degrees or in other directions), and the spatial relationship descriptors used herein will be explained accordingly.

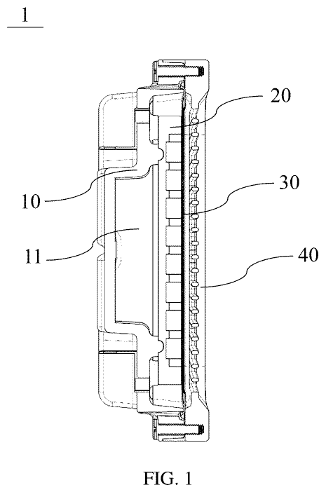

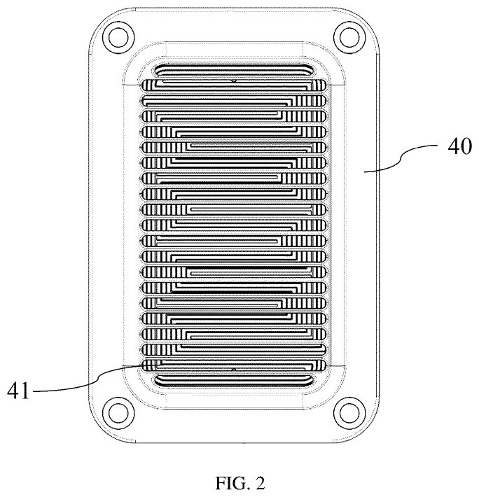

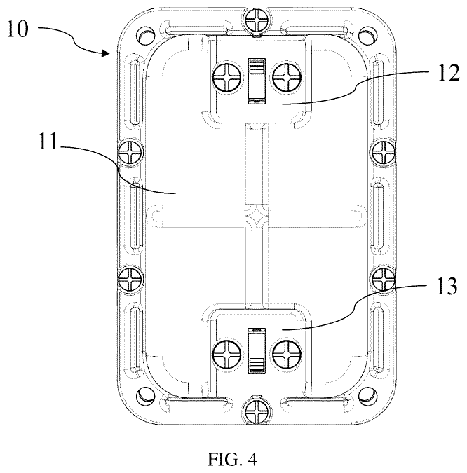

As shown in FIGS. 1 to 9, in some embodiments of the present disclosure, the planar transducer 1 includes a basket 10, a magnetic circuit assembly 20, a membrane assembly 30, and a cover plate 40. Specifically, an accommodation chamber 11 is provided in the interior of the basket 10, a magnetic circuit assembly 20 is provided inside the accommodation chamber 11, and a membrane assembly 30 covers an opening at one end of the accommodation chamber 11, thereby forming a magnetic circuit in the interior of the accommodation chamber 11 so that the membrane assembly 30 at the opening of the accommodation chamber 11 is excited to vibrate and generate sound energy. The magnetic circuit assembly 20 of this embodiment includes a magnetically conductive plate 21 and a magnet assembly 22 attached to a plate surface of the magnetically conductive plate 21. The magnet assembly 22 includes N first magnets 221 and N−1 second magnets 222, where N is larger than or equal to 3. The first magnets 221 and the second magnets 222 are alternately attached to each other in sequence without a gap between them. A magnetic pole direction of the first magnets 221 and a magnetic pole direction of the second magnets 222 are perpendicular to each other, and any two adjacent magnets that are of the same type and arranged alternately with the other type of magnet in the magnet assembly 22 have opposite magnetic pole directions. The membrane assembly 30 includes a base layer 31 and a voice coil layer 32. The base layer 31 is provided at the opening of the accommodation chamber 11 and covers the opening; the voice coil layer 32 is attached to one side of the base layer 31, and the other side of the base layer 31 is arranged toward the magnetic circuit assembly 20. The cover plate 40 is also provided at the opening at the end of the accommodation chamber 11 and covers the opening, and the cover plate 40 is arranged opposite to the voice coil layer 32. Therefore, a box structure is formed by the cover plate 40 and the basket 10, and the magnetic circuit assembly 20 and the membrane assembly 30 are placed inside the box structure formed by the cover plate 40 and the basket 10, thereby facilitating the assembly and sound production of the planar transducer 1. There are multiple first sound output holes 41 provided on the cover plate 40, and the sound generated from the front side of the membrane assembly 30 during vibration can be transmitted to the outside through the first sound output holes 41.

According to the planar transducer 1 of the present disclosure, multiple first magnets 221 and multiple second magnets 222 are alternately attached in sequence, the magnetic pole direction of the first magnets 221 and the magnetic pole direction of the second magnets 222 are perpendicular to each other, and any two adjacent magnets that are of the same type and arranged alternately with the other type of magnet in the multiple magnets have opposite magnetic pole directions; therefore, by arranging the multiple magnets in a Halbach array, the magnetic flux of the magnetic circuit assembly 20 is effectively increased and the sensitivity of the planar transducer is thereby improved. At the same time, the voice coil layer 32 is placed on one side face of the base layer 31, and the magnetic circuit assembly 22 is placed on the other side face of the base layer 31. When the planar transducer 1 vibrates and emits a sound, the membrane assembly 30 vibrates and emits a sound under the action of the magnetic field of the magnetic circuit assembly 20, and the sound is transmitted from the side face of the base layer 31 that is provided with the voice coil layer 32 to the outside of the basket 10. During the transmission of sound, it is not obstructed or interfered by magnets, thereby reducing sound distortion and making the frequency response curve flatter, effectively improving the sound quality of the planar transducer 1.

Specifically, as shown in FIGS. 1 to 4, in some embodiments of the present disclosure, the accommodation chamber 11 is formed in the interior of the basket 10 for mounting the magnetic circuit assembly 20. A first mounting seat 12 and a second mounting seat 13 are spaced apart in a length direction inside the accommodation chamber 11. Two ends of the magnetic circuit assembly 20 in the length direction are fixedly connected to the first mounting seat 12 and the second mounting seat 13 respectively, which can be specifically implemented by bolt connection.

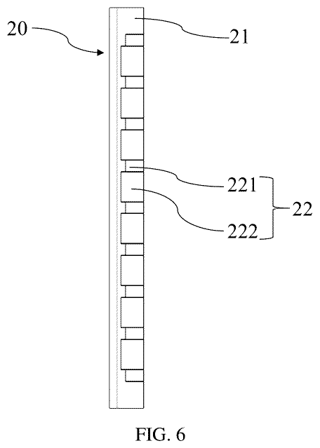

As shown in FIGS. 6 to 8, in some embodiments of the present disclosure, the magnetic circuit assembly 20 includes the magnetically conductive plate 21 and the magnet assembly 22 attached to the plate surface of the magnetically conductive plate 21. The magnet assembly 22 includes nine first magnets 221 and eight second magnets 222. The first magnets 221 and the second magnets 222 are alternately attached to each other in sequence. Specifically, the first magnets 221 and the second magnets 222 are connected by adhesive to form the magnet assembly 22 and facilitate connection with the magnetically conductive plate 21. The direction of the magnetic induction line of the first magnet 221 is parallel to the plate surface of the magnetically conductive plate 21, and the direction of the magnetic induction line of the second magnet 222 is perpendicular to the plate surface of the magnetically conductive plate 21. In addition, any two adjacent magnets that are of the same type and arranged alternately with the other type of magnet in the magnet assembly 22 have opposite magnetic pole directions, that is, the magnetic pole directions of two second magnets 222 located on both sides of the same first magnet 221 are opposite, or the magnetic pole directions of two first magnets 221 located on both sides of the same second magnet 222 are opposite. For the purpose of description, “↑”, “↓”, “←” and “→” are used respectively to indicate the direction of the magnetic induction line, where the arrows represent the direction of the N pole. According to the number of magnets in an ascending order, the following distribution pattern can be formed:
when the number of magnets in the magnet assembly 22 is five, including three first magnets 221 and two second magnets 222, the magnetic field distribution direction in the magnet assembly 22 is “→↑←↓→”;
when the number of magnets in the magnet assembly 22 is seven, including four first magnets 221 and three second magnets 222, the magnetic field distribution direction in the magnet assembly 22 is “→↑←↓→↑←”;
when the number of magnets in the magnet assembly 22 is nine, including five first magnets 221 and four second magnets 222, the magnetic field distribution direction in the magnet assembly 22 is “→↑←↓→↑←↓→”; and
when the number of magnets in the magnet assembly 22 is eleven, including six first magnets 221 and five second magnets 222, the magnetic field distribution direction in the magnet assembly 22 is “→↑←↓→↑←↓→↑↓”.

In this embodiment, the number of magnets in the magnet assembly 22 is seventeen, including nine first magnets 221 and eight second magnets 222, the magnetic field distribution direction in the magnet assembly 22 is “→↑←↓→↑←↓→↑←↓→↑←↓→”.

In other embodiments, when permitted by the size and quality, the Halbach array can continue to expand according to requirements.

Based on the above arrangement of the first magnets 221 and the second magnets 222, it can be seen that the magnet assembly 22 of this embodiment is distributed according to the Halbach array. The Halbach array can greatly increase the magnetic force of the planar magnetic field, so it is only required to set a set of Halbach array on one side of the membrane assembly 30 to achieve a high-density magnetic field. Therefore, no magnets are arranged in the sound output direction of the membrane assembly 30, which reduces or avoids the obstruction and interference of sound during transmission, greatly reducing sound distortion and making the frequency response curve flatter.

The Halbach array is an arrangement of permanent magnets. The permanent magnets having different magnetization directions are arranged in a certain order, so that the magnetic field on one side of the array is significantly enhanced. Halbach, which is an American, invented this distribution (which was applied for patent in 1979), but the distribution is integrated and improved in the present disclosure and first applied in the field of speakers.

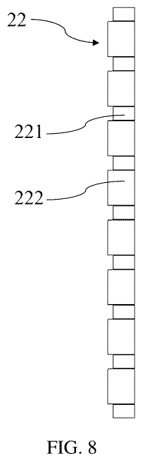

As shown in FIG. 8, unlike the Halbach array, in some embodiments of the present disclosure, in a direction perpendicular to the plate surface of the magnetically conductive plate 21, a height dimension of the first magnet 221 in this embodiment is smaller than a height dimension of the second magnet 222, and a cross-sectional area of the first magnet 221 is smaller than that of the second magnet 222.

As shown in FIG. 8, unlike the Halbach array, in some embodiments of the present disclosure, in a direction parallel to the plate surface of the magnetically conductive plate 21, a width dimension of the first magnet 221 in this embodiment is smaller than a width dimension of the second magnet 222, and a cross-sectional area of the first magnet 221 is smaller than that of the second magnet 222.

As shown in FIG. 8, unlike the Halbach array, in some embodiments of the present disclosure, surfaces of any adjacent first magnet 221 and second magnet 222 that face the base layer 31 are flush, and surfaces of any adjacent first magnet 221 and second magnet 222 that face the magnetically conductive plate 21 are alternately arranged in a concave and convex pattern, which facilitates assembling and fixing the first magnets 221 and the second magnets 222 with the magnetically conductive plate 21.

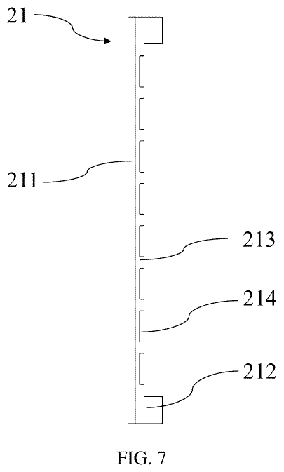

As shown in FIGS. 6 and 7, unlike the Halbach array, in some embodiments of the present disclosure, in order to match the mounting of the first magnets 221 and the second magnets 222, the magnetically conductive plate 21 is added on the basis of the Halbach array. The magnetically conductive plate 21 includes a main plate portion 211 and side plate portions 212 arranged on both sides of the main plate portion 211. The main plate portion 211 and the side plate portions 212 on both sides together enclose a U-shaped structure, and multiple first magnets 221 and multiple second magnets 222 are all arranged in the U-shaped structure and attached to the plate surface of the main plate portion 211.

Specifically, N protrusions 213 and N−1 recesses 214 are provided on the plate surface of the main plate portion 211 that faces the magnet assembly 22. The number of protrusions 213 is consistent with the number of first magnets 221, the number of recesses 214 is consistent with the number of second magnets 222, and the arrangement of the N protrusions 213 and the N−1 recesses 214 is consistent with the arrangement of the N first magnets 221 and the N−1 second magnets 222. A height difference between the protrusion 213 and the recess 214 is consistent with a height difference between the first magnet 221 and the second magnet 222, a width dimension of the protrusion 213 is consistent with a width dimension of the first magnet 221, and a width dimension of the recess 214 is consistent with a width dimension of the second magnet 222. Therefore, when the magnet assembly 22 is assembled with the magnetically conductive plate 21, the second magnet 222 can be clamped between two protrusions 213 and abut against the recess 214, and the protrusion 213 can be clamped between two second magnets 222 and abut against the first magnet 221, thereby achieving seamless connection between the magnet assembly 22 and the magnetically conductive plate 21, ensuring that the magnetic circuit assembly 20 has the maximum magnetic flux. The side plate portions 212 located on both sides of the main plate portion 221 surround the magnet assembly 22, further preventing magnetic field diffusion or leakage of the magnet assembly 22.

Compared to the traditional Halbach array, the magnet assembly 22 of this embodiment is improved based on the original Halbach array. Firstly, the cross-sectional dimensions of all magnets in the original Halbach array are consistent, while in the magnetic circuit assembly 20 of this embodiment, the cross-sectional area of magnets with magnetic induction lines in the horizontal direction (← and →) is reduced, that is, the cross-sectional area of the first magnets 221 is reduced, so as to shorten the horizontal distance between two adjacent second magnets 222, reduce the magnetic gap between two second magnets 222 and enhance the magnetic force in the magnetic gap, while also facilitating assembling the magnetic circuit assembly 20 and lowering the cost; secondly, the magnetic circuit assembly 20 of this embodiment is further provided with a magnetically conductive plate 21 on the periphery of magnets of the original Halbach array; the arrangement of the magnetically conductive plate 21 can further enhance the magnetic flux of the magnetic circuit assembly 20, prevent magnetic field diffusion or leakage, and facilitate the assembly and fixation of the magnet assembly 22.

The biggest advantage of the magnetic circuit assembly 20 of this embodiment is that the surface magnetic flux of the planar magnetic field is increased. Assuming that the magnetic circuit is composed of neodymium-iron-boron strong magnets that are all labelled N50, the surface magnetic flux of traditional planar equimagnetic fields is generally about 3000 G-4000 G (G is the Gaussian unit). The original Halbach array can reach about 5000 G-6000 G, while the Halbach array with the addition of U-shaped magnetically conductive plate can reach about 6000 G-7000 G or even higher, greatly improving the magnetic flux of planar magnetic fields. Therefore, when using this improved magnetic circuit that can achieve nearly two times or more the magnetic flux of an ordinary planar magnetic field, its sensitivity or efficiency will also be increased by two times or more. Therefore, simply placing one set of magnetic circuit assembly 20 of this embodiment on one side of the membrane assembly 30 can outperform two sets of traditional magnetic circuits placed on both sides of the membrane respectively, thereby eliminating the obstruction of magnets in the sound output direction of the membrane assembly 30. The sound emitted by the membrane assembly 30 will not be obstructed or interfered during transmission, thereby reducing distortion and making the frequency response curve flatter.

For traditional planar membrane materials, an ultra-thin nanoscale polyester film is used as the base layer, and a layer of aluminum foil is formed on the base layer under negative pressure; then a circuit is formed by etching, so that a planar circuit voice coil is finally formed. The most important reason for using this kind of material is to achieve the lightest mass per unit area of the membrane, thereby obtaining a higher sound pressure level, as well as ductility and analytical power at high frequency. Many brands take pride in this, but this polyester film similar to cling film has defects such as poor toughness, low rigidity modulus, and insufficient recovery force, which will reduce the quality of the membrane and the high fidelity of the sound. The first reason is that the sound is light and thin, lacking a sense of weight, and is not mellow enough. The second reason is that the light and thin membrane can cause distortion at medium and low frequencies in case of high power. The third reason is that the sound quality of etched aluminum voice coil will exhibit sharp and piercing burr sensation at high frequency.

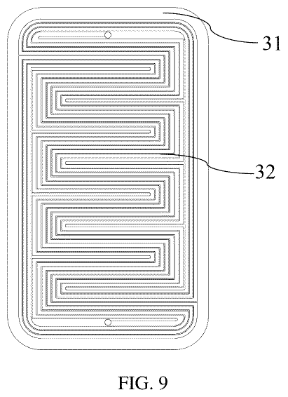

As shown in FIG. 9, in some embodiments of the present disclosure, the base layer 31 and the voice coil layer 32 are of an integrated structure. The base layer 31 is made of DuPont standard PI film with a thickness of micron level, that is, a median value of the thickness is about 12.5 μm, with an upper limit of 25 μm and a lower limit of 6-8 μm, which is more than three times the thickness of traditional polyester film membranes, and its rigidity modulus is as high as tens of times. The voice coil layer 32 is made of electrolytic copper attached to a surface of the PI film, and the electrolytic copper is etched to form the voice coil layer.

Further, in some embodiments of the present disclosure, the membrane assembly 30 further includes an anti-oxidation coating sprayed onto a surface of the electrolytic copper of the voice coil layer 32. By spraying a layer of ink, soft glue, or similar material onto the surface of the electrolytic copper of the voice coil layer 32, on one hand, oxidation of the electrolytic copper on the voice coil layer 32 can be effectively prevented, and on the other hand, distortion of the membrane assembly 30 generated during vibration can be avoided. The distortion includes “swoosh” noise similar to that generated by shaking or rubbing paper sheets, high-frequency harmonic distortion generated by the segmentation vibration of the membrane assembly 30, and “hiss” noise similar to burrs generated in the high-frequency region.

In some embodiments of the present disclosure, for the base layer 31 of the membrane assembly 30, the traditional polyester film is abandoned, and DuPont standard PI (polyimide) film is adopted. For the voice coil layer 32, the traditional aluminum foil is abandoned, and the electrolytic copper that is not easily magnetized is adopted. Ink, soft glue or similar material is sprayed on the surface of the electrolytic copper for anti-oxidation and noise reduction treatment, thereby overcoming the defects of poor toughness, low rigidity modulus, and insufficient recovery force of the membrane assembly 30. Moreover, no distortion will be produced during high-power operation, resulting in sufficient mid-range and subwoofer volume, rich details, and mellow and full sound. The use of electrolytic copper in the voice coil layer will reduce impedance and inductance, which is advantageous for the promotion of power amplifiers and the extension of high frequencies. The ink, soft glue or similar material sprayed on its surface will also further increase the toughness of the membrane assembly 30 to reduce segmentation vibration and cover the burr sensation at high frequency.

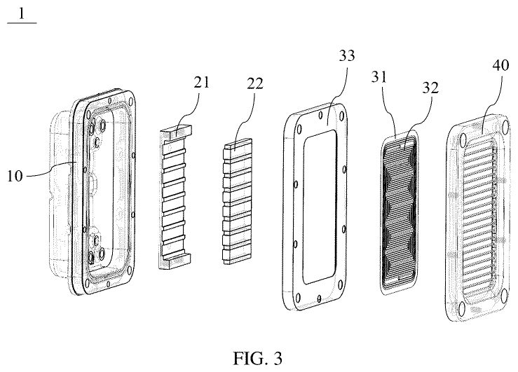

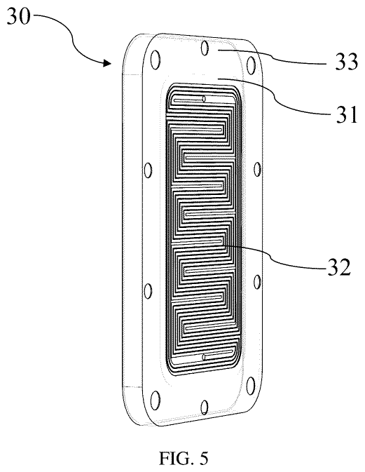

As shown in FIGS. 3 and 5, in some embodiments of the present disclosure, the membrane assembly 30 further includes a hanging edge 33. It should be noted that except for traditional dome tweeter and mid-range speaker units or conical speaker units, traditional tweeter and mid-range speaker units or headphone speaker units having this type of planar membrane do not have hanging edges. The hanging edge, also known as “edge” or “folding ring”, is a flexibly connected hanging component between vibrating components such as membrane and vibrating plate and fixed parts such as basket and speaker box wall. It is usually made of rubber or other materials, hence commonly known as “rubber edge”. The hanging edge 33 is arranged around the edge of the base layer 31, and the base layer 31 is connected to the basket 10 through the hanging edge 33. The main purpose of adding the hanging edge 33 in some embodiments of the present disclosure is to apply a certain tension to the membrane assembly so that it is fully tightened or elastically adjusted, and then laid flat at the opening at one end of the accommodation chamber 11 in the basket 10. The hanging edge 33 is made of elastic gel, which not only tightens or elastically adjusts the membrane assembly 30, but also effectively overcomes the defects of the membrane assembly 30 such as poor toughness, low rigidity modulus, and insufficient recovery force. Moreover, it does not produce distortion at medium and low frequencies during high-power operation, and results in sufficient mid-range and subwoofer volume, rich details, and mellow and full sound.

Another aspect of the present disclosure also provides a speaker, which is a speaker unit capable of emitting plane waves as wavefront. This speaker unit can be either a tweeter speaker unit or a mid-range speaker unit in a speaker system, and importantly, it can also be used as a headphone speaker unit in the design of headphone products. Regardless of the purpose, it has the planar transducer 1 according to any of the above embodiments, effectively reducing sound distortion and making the frequency response curve flatter, thereby effectively improving the sound quality of such speakers. However, it should be pointed out that all embodiments of the present disclosure belong to the core part of the unit itself. If specifically applied to a tweeter speaker unit, a mid-range speaker unit, or a headphone speaker unit, adjustments should be made according to the specific situation and structure in their respective applications. For example, the tweeter speaker unit and the mid-range speaker unit should be mounted in a dedicated speaker box, and the headphone speaker unit should be mounted in the headphone housing.

Described above are only preferred specific embodiments of the present disclosure, but the scope of protection of the present disclosure is not limited to this. Any changes or replacements that can be easily conceived by those skilled in the art within the technical scope disclosed by the present disclosure should be covered within the scope of protection of the present disclosure. Therefore, the scope of protection of the present disclosure should be accorded with the scope of protection of the claims.

1. A planar transducer, comprising:
a basket, inside which an accommodation chamber is provided, one end of the accommodation chamber having an opening;
a magnetic circuit assembly, which is arranged in the accommodation chamber, and which comprises a magnetically conductive plate and a magnet assembly attached to a plate surface of the magnetically conductive plate; wherein the magnet assembly comprises N first magnets and N−1 second magnets, where N is larger than or equal to 3; the first magnets and the second magnets are alternately attached to each other in sequence, a magnetic pole direction of the first magnets and a magnetic pole direction of the second magnets are perpendicular to each other, and any two adjacent magnets that are of the same type and arranged alternately with the other type of magnet in the magnet assembly have opposite magnetic pole directions;
a membrane assembly, which comprises a base layer and a voice coil layer; wherein the base layer is provided at an opening of the accommodation chamber and covers the opening, the voice coil layer is attached and connected to one side of the base layer, and the other side of the base layer is arranged toward the magnetic circuit assembly; and
a cover plate, which is provided at the opening of the accommodation chamber and covers the opening, and which is arranged opposite to the voice coil layer, a first sound output hole being provided on the cover plate.

2. The planar transducer according to claim 1, wherein the direction of the magnetic induction lines of the first magnet is parallel to the plate surface of the magnetically conductive plate, and the direction of the magnetic induction lines of the second magnet is perpendicular to the plate surface of the magnetically conductive plate; or the direction of the magnetic induction lines of the first magnet is perpendicular to the plate surface of the magnetically conductive plate, and the direction of the magnetic induction lines of the second magnet is parallel to the plate surface of the magnetically conductive plate.

3. The planar transducer according to claim 1, wherein end surfaces of any adjacent first magnet and second magnet on a side facing the magnetically conductive plate are alternately arranged in a concave and convex pattern, and end surfaces of any adjacent first magnet and second magnet on a side away from the magnetically conductive plate are flush.

4. The planar transducer according to claim 1, wherein in a direction perpendicular to the plate surface of the magnetically conductive plate, a height dimension of the first magnet is smaller than a height dimension of the second magnet, and a cross-sectional area of the first magnet is smaller than that of the second magnet.

5. The planar transducer according to claim 1, wherein in a direction parallel to the plate surface of the magnetically conductive plate, a width dimension of the first magnet is smaller than a width dimension of the second magnet, and a cross-sectional area of the first magnet is smaller than that of the second magnet.

6. The planar transducer according to claim 1, wherein the magnetically conductive plate comprises a main plate portion and side plate portions arranged on both sides of the main plate portion; the main plate portion and the side plate portions on both sides together enclose a U-shaped structure, and the multiple magnets are arranged inside the U-shaped structure and are attached to the plate surface of the main plate portion.

7. The planar transducer according to claim 1, wherein the base layer and the voice coil layer of the membrane assembly are of an integrated structure, the base layer is a PI film and the voice coil layer is electrolytic copper attached to a surface of the PI film, and the electrolytic copper is etched to form the voice coil layer.

8. The planar transducer according to claim 7, wherein the membrane assembly further comprises an anti-oxidation coating that covers a surface of the electrolytic copper of the voice coil layer.

9. The planar transducer according to claim 1, wherein the membrane assembly further comprises a hanging edge, which is arranged around an edge of the base layer, and the base layer is connected to the basket through the hanging edge.

10. A speaker, comprising the planar transducer according to claim 1.
